(19) United States
(12) Patent Application Publication
(10) Pub. No.: US 2018/0285748 A1
(43) Pub. Date: Oct. 4, 2018

(54) PERFORMANCE METRIC PREDICTION FOR DELIVERY OF ELECTRONIC MEDIA CONTENT ITEMS

(71) Applicant: Facebook, Inc., Menlo Park, CA (US)

(72) Inventors: Aliasgar Mumtaz Husain, Milpitas, CA (US); Pan Jiang, San Mateo, CA (US)

(21) Appl. No.: 15/475,651

(22) Filed: Mar. 31, 2017

(51) Int. Cl. G06N 5/04; G06N 99/00

(52) U.S. Cl. CPC G06N 5/04; G06N 99/005

(57) ABSTRACT

An online system stores information describing delivery of content items to users. The information includes a time of delivery and a content item type for each content item delivered. The system receives a new content item from a content provider for distribution. The system extracts a new feature vector from the new content item. The new feature vector includes a content item type of the new content item. The system provides the new feature vector to a machine learning model, which generates a predicted performance metric for the new content item for each of several time periods based on the new feature vector. The system sends, to the content provider, the generated predicted performance metrics. The system receives, from the content provider, a selection of time periods for delivering the new content item.

### BACKGROUND

This disclosure relates generally to delivery of electronic media content items and in particular to predicting performance metrics for electronic media content items delivered via client devices to an online audience.

Content providers and social networking systems often present content items to users. Such content items are viewed by users on client devices, for example, a laptop or a mobile device. Users typically interact with content items by clicking on them, sharing them with their social networking connections, making financial transactions, etc. on a client device.

A content item may include text, images, audio clips, links, etc. The user experience provided by a content item often depends on the time period during which the content item is delivered to a user, what is presented in the content item, and the profile of the user to whom the content item is delivered. Conventional techniques by content providers and online publishers for delivering content items to users of social networking systems or other websites sometimes provide poor user experience. Furthermore, sending content items to users that are not interested in the content item results in waste of networking bandwidth and computing resources. Poor user experience leads to fewer user interactions with content items. Fewer user interactions may result in lower user membership of the social network. For example, users may be less likely to engage with an online system if the content items provided by the online system are not of interest to the users.

### SUMMARY

An online system uses a machine learning model to predict performance metrics for content items (video clips, text, etc.), such as the likelihood of users interacting with the content items during certain time periods or the cost of delivering the content items during each time period based on an analysis of similar content items (e.g., with a similar content item type). Examples of user interactions with a content item include accessing the content item, closing the content item, sharing the content item with other users, and so on. In an embodiment, a machine learning model generates a predicted performance metric for a content item for several time periods based on a feature vector extracted from the content item. In an embodiment, the machine learning model is trained based on the stored information describing past delivery of the content items and feature vectors extracted from the content items delivered.

In one embodiment, the online system stores information describing the delivery of content items to users of the online system. The information describing delivery of a content item to a user includes a time of the delivery and a content item type of the content item delivered to the user. The online system receives a new content item from a content provider for distribution by the online system. The online system extracts a feature vector from the new content item. The feature vector includes a content item type of the new content item. The online system provides the extracted new feature vector to the machine learning model. The machine learning model generates a predicted performance metric for the new content item for each of the time periods based on the new feature vector. The online system delivers the new content item to users based on the predicted performance metric. In an embodiment, the online system sends the generated predicted performance metrics for the time periods to the content provider. The online system receives a selection of one or more time periods for delivering the new content item from the content provider and delivers the content item in accordance with the received selection.

### BRIEF DESCRIPTION OF THE DRAWINGS

FIG. 1 is a block diagram of an example system environment in which an online system operates, in accordance with an embodiment.

FIG. 2 is a block diagram of an example system architecture of the online system, in accordance with an embodiment.

FIG. 3 illustrates an example process of predicting performance metrics for content items, in accordance with an embodiment.

FIG. 4 illustrates an example process for training a machine learning model, in accordance with an embodiment.

FIG. 5 illustrates an example process for generating a performance metrics vector based on the machine learning model, in accordance with an embodiment.

FIG. 6 illustrates an example process for generating a performance metrics vector based on filtering content delivery information, in accordance with an embodiment

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Example System Environment

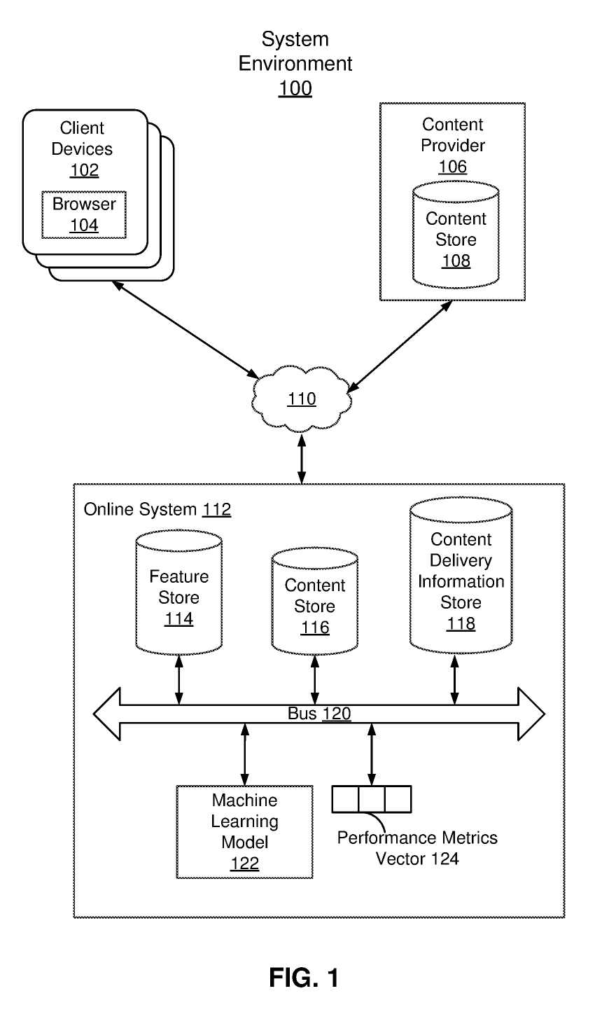

FIG. 1 is a block diagram of an example system environment 100 in which an online system 112 operates, in accordance with an embodiment. The system environment 100 shown in FIG. 1 includes a content provider 106, client devices 102, a network 110, and the online system 112. The term “content item” refers to “electronic media content item” herein.

The online system 112 receives content items from the content provider 106 for distribution by the online system 112. The content provider 106 may be a provider of sponsored content such as a political campaign, a university, a corporation, the government, etc. Sponsored content includes content items for which the content provider 106 provides remuneration to the online system 112 for targeting and distribution of the content items to the client devices 102 of an online audience. Content items may be images, text paragraphs, video clips, audio clips, hyperlinks, online forms, etc. Examples of sponsored content include online advertisements. The content provider 106 may include a content store 108 for storing content items.

The online system 112 or third-party websites present content items to the client devices 102. A client device 102 is used for interacting with the online system 112 or with third-party websites such as online publishers using the browser 104. The client device 102 is a computing device capable of receiving user input as well as transmitting and/or receiving data via the network 110. In one embodiment, the client device 102 is a conventional computer system, such as a desktop or laptop computer. Alternatively, the client device 102 may be a device having computer functionality, such as a personal digital assistant (PDA), a mobile telephone, a smartphone or another suitable device.

In one embodiment, the client device 102 executes an application allowing a user to interact with the online system 112. The client device 102 may execute an application, for example, the browser 104, to enable interaction between the client device 102 and the online system 112 via the network 120. In another embodiment, the client device 102 interacts with a third-party website such as an online publisher through an application programming interface (API) running on a native operating system of the client device 102, such as IOS® or ANDROID™. A user may download content items from the online system 112 to the client device 102 using browser 104 and interact with the content items by clicking on a link in a content item, filling in user information into an online form, closing the content item using a “close window” button on the browser 104 or on the client device 102, etc.

The content provider 106, client devices 102, and online system 112 are configured to communicate via the network 110 shown in FIG. 1, which may include any combination of local area and/or wide area networks, using both wired and/or wireless communication systems.

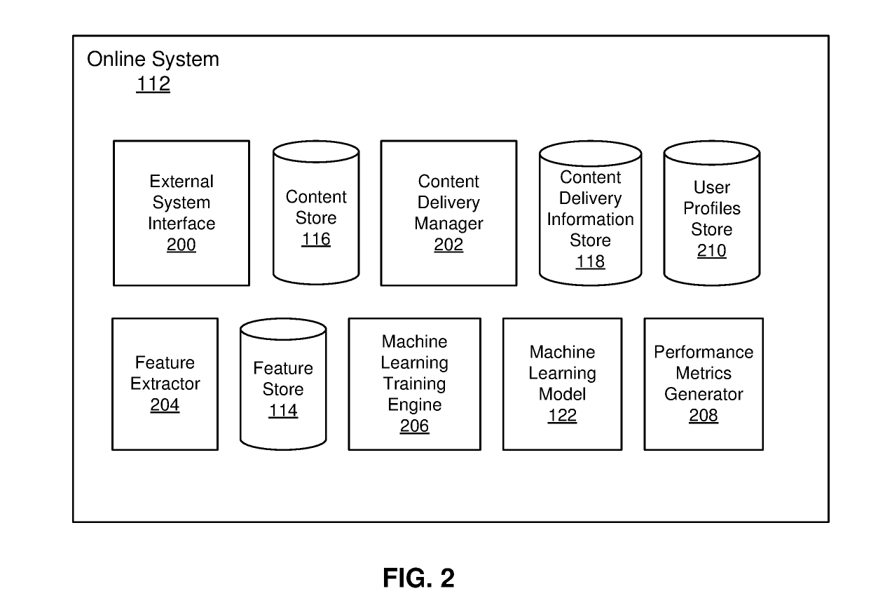

In one embodiment, the online system 112 may be a social networking system. The online system 112 may include a content store 116, feature store 114, content delivery information store 118, a machine learning model 122, and a bus 120. The content store 116 shown in FIG. 1 is used to store content items received from the content provider 106. The feature store 114 is used to store features of content items extracted by a feature extractor, as described below with reference to FIG. 2. A feature of a content item may be a content item type of the content item or a content provider type of the content provider 106 who provided the content item to the online system 112.

The content delivery information store 118 stores information describing the delivery of content items to users of the online system 112. The information for each delivery of a content item to a user includes a time of the delivery and a content item type of the content item delivered to the user.

The online system 112 provides feature vectors of content items to a machine learning model 122. The machine learning model 122 is trained based on the stored information describing the delivery of the content items and feature vectors extracted from the content items to generate a predicted performance metric for a content item for each of several time periods based on a feature vector extracted from the content item. The machine learning model 122 receives as input a new feature vector for a new content item from the content store 116. The machine learning model 122 generates a predicted performance metrics vector 124 for the new content item for the time periods based on the new feature vector.

The content store 116, feature store 114, content delivery information store 118, and the machine learning model 122 are configured to communicate via the bus 120. The online system 112 sends, to the content provider 106, the generated predicted performance metrics vector 124 for the several time periods. The online system 112 receives, from the content provider 106, a selection of one or more time periods for delivering the new content item.

The online system 112 as disclosed processes data within a content item into a digital representation of performance metrics such as online audience preferences. Advantages of the system include providing content to users at a time that users are more likely to interact with the content. Other advantages of the system include improving the efficiency of the distribution of content since content not relevant at a particular time to a user is not transmitted via the network thereby avoiding waste of network bandwidth and computing power.

### Example System Architecture

FIG. 2 is a block diagram of an example system architecture of the online system 112, in accordance with an embodiment. The architecture of the online system 112 includes an external system interface 200, the content store 116, a content delivery manager 202, the content delivery information store 118, a user profiles store 210, a feature extractor 204, a feature store 114, a machine learning training engine 206, the machine learning model 122, and a performance metrics generator 208.

The external system interface 200 is a dedicated hardware networking device or software module that receives data packets representing content items from the content provider 106 and data packets representing information describing delivery of content items to users of the online system 112. The external system interface 200 may receive at least a portion of the information describing the delivery of the content items from client devices 102 responsive to rendering tracking pixels on websites of the online system 112. The external system interface 200 forwards data packets representing content items and performance metrics vectors to the content provider 106. In one example, the external system interface 401 forwards data packets at high speed along the optical fiber lines of the Internet backbone. In another example, the external system interface 401 exchanges routing information using the Border Gateway Protocol (BGP) and may be an edge router, a border router, or a core router.

The content store 116 is used to store content items received from the content provider 106. The content store 116 may be organized as a database, table, file, etc. stored on one or more of removable or non-removable memory cards and computer hard drives. The content store 116 may include multiple data fields, each describing one or more attributes of the content items. For example, the content store 116 may contain, for a single content item, the content provider 106 of the content item, a list of topics of the content item, whether the content item is for a particular product, etc.

The content delivery manager 202 sends content items to client devices 102 of users of the online system 112 via the external system interface 200. The content delivery manager 202 also receives data packets representing information describing the delivery of content items to users of the online system 112 via the external system interface 200. The information for each delivery of a content item to a user includes a time of the delivery (e.g., 7:00 a.m. EST on Saturday, Jan. 14, 2017) and a content item type (e.g., advertisement for a particular men's cologne) of the content item delivered to the user. The content delivery manager 202 populates the content delivery information store 118 with the information describing the delivery of content items to users of the online system 112.

In one embodiment, the online system 112 includes tracking pixels in the content items presented to client devices 102 such that when a content item is presented via the browser 104 of the client device 102, a particular program or code (or set of instructions) is executed by the browser 104. This code associated with a tracking pixel causes a browser identifier associated with the user to be sent to the content delivery manager 202. A tracking pixel may be a transparent 1×1 image, an iframe, or other suitable user interface object. The content delivery manager 202 may receive the information describing the delivery of content items to users of the online system 112 from tracking pixels displayed on websites of the online system 112.

The content delivery manager 202 may also receive the information describing the delivery of content items from tracking pixels displayed on third-party websites. For example, after a user has clicked on a content item on a website of the online system 112, the user may purchase a product related to the content item on a third-party website or a mobile application, or otherwise interact with a third-party website related to the content item. When the user's client device 102 receives a page from the third-party website, a tracking pixel may fire, causing the browser 104 to send information to the online system 112 about the user interactions performed by the user on the third-party website.

The content delivery information store 118 stores the information describing the delivery of content items. The information for each delivery of a content item to a user may include a user profile of the user performing user interactions with the content item, e.g., the age of the user, gender of the user, location of the user, etc. The information for each delivery of a content item to a user may include a number of the user interactions with the content item. For example, that the user interacted with the content item 7 times and the time (e.g., 2:00 p.m. EST on Saturday, Jan. 14, 2017) for each user interaction.

The content delivery information store 118 may store the browser identifier associated with the user obtained from the browser application 104, information describing the user interaction performed, and a time stamp value indicating the time at which the user interaction was performed. The content delivery information store 118 may include past user interactions, such as clicking on a link in a content item, filling in user information into an online form, closing the content item using a “close window” button on the client device, sharing a content item by sending it to another user who is connected to the first user's online account, commenting on posts linked to a content item, checking-in to physical locations linked to a content item via a mobile device, joining an event linked to a content item to a calendar, joining a user group linked to a content item, expressing a preference for a content item, e.g., “liking” the content item, engaging in a transaction linked to a content item, etc.

The content delivery information store 118 may also store information describing past user interactions with other content items having the same content item type. For example, if the content item type of a content item is “advertisement for a carbonated beverage,” the content delivery information store 118 may store information describing past user interactions with other content items representing online advertisements for carbonated beverages.

In one embodiment, data from the content delivery information store 118 may be used to infer interests or preferences of a user, augmenting the interests included in the user profile of the user on the online system 112, and allowing a more complete understanding of user preferences for content items. In another embodiment, a user of the system may interact with content items, and that interaction may be reported to connections of the user in the online system via a “newsfeed” or other mechanism for providing information to users. Users and content items within the online system 112 can be represented as nodes in a social graph that are connected by edges. The edges indicate the relationships between the users, such as a connection within a social network, or the edges represent interactions by users with content items.

The content delivery information store 118 may store the cost of delivering each content item to users, which may represent the remuneration charged by the online system 112 to the content provider 106 for delivering the content item at a certain time to client devices 102. The content delivery information store 118 may store the reach of each content item, which may represent the number of different users (or client devices 102) receiving the content item at least once during a particular time period (e.g., a certain four-week period) or the average number of times a user received a content item over a particular time period. The reach of a content item may also represent the number of unique deliveries of the content item to a user. For example, if the same content item was delivered 10 times to a particular user, the reach would be determined as 1.

The content delivery information store 118 may store the number of deliveries of each content item, e.g., the number of different times a content item was embedded in a webpage of the online system 112. For example, if the same content item was delivered 10 times to a particular user, the number of deliveries of the content item would be determined as 10.

The user profiles store 210 stores social networking user profiles of users of the online system 112. The user profiles store 210 may be organized as a database, table, file, etc. stored on one or more of removable or non-removable memory cards or computer hard drives. In one embodiment, the user profiles store 210 includes multiple data fields, each describing one or more attributes of the users. The user profiles store 210 may contain, for a single user, the financial status of the user (e.g., income, homeowner or renter status, etc.), age of the user (e.g., 45), gender of the user (e.g., female), location of the user (e.g., last observed GPS coordinates, country, zip code, etc.), educational level of the user (e.g., college graduate, school information, diplomas, etc.), religious background of the user (e.g., unaffiliated), relationship status of the user (e.g., married), location of employment of the user (e.g., government, city, state, etc.), residence location of the user (e.g., city, state, resident of one state temporarily living in another state, etc.), interests of the user (e.g., football, sewing, dogs, tech savvy, etc.), parenting status of the user (e.g., having two children, new parent, children go to college, etc.), traveling preferences of the user (e.g., travel frequency, ticket agency preference, prefers flights vs. road-trips), dining preferences of the user (e.g., dining out frequency, favorite restaurant, etc.), client device preferences of the user (e.g., smartphone, laptop, etc.), online purchasing activity (e.g., purchases three times a month, average amount spent in the last three months, brands purchased, favorite stores, etc.), online search activities (e.g., recently searched topics), reaction to online advertisements (e.g., frequency of clicking on advertisements, advertisement type preferences, etc.), internet activities (e.g., login frequency, browsing duration, etc.).

In an embodiment, the user profiles store 210 stores information describing social networking connections of a user. The information describing the social networking connections may include an aggregate range of financial status of other users connected to the user (e.g., incomes between $60,000 and $100,000 with a median of $50,000), an aggregate range of age of other users connected to the user (e.g., 30-40 with a median of 33), an aggregate value based on genders of other users connected to the user (e.g., 30% female and 70% male), an aggregate value based on locations of other users connected to the user (e.g., 70% of other users are located in Texas), an aggregate value based on educational levels of other users connected to the user (e.g., 50% of social networking connections of the user have college degrees), an aggregate value based on relationship status of other users connected to the user (e.g., 10% of social networking connections of the user are married), an aggregate value based on locations of employment of other users connected to the user (e.g., 80% of social networking connections of the user work for the government), an aggregate value based on residence locations of other users connected to the user (e.g., 20% of social networking connections of the user live in New York).

The feature extractor 204 extracts a feature vector from a content item. The features may be used by the machine learning model 122 for training as well as for generating the performance metrics vector 124. A feature of the feature vector extracted from a content item may represent the content item type of the content item, e.g., whether the content item represents an advertisement for a certain automobile, etc. and the feature extractor 204 may analyze the content item to identify the content item type. For example, the feature extractor 204 may perform image analysis on an image in the content item, text transcription for an audio clip in the content item, text analysis on metadata embedded in the content item, etc.

In one embodiment, the feature extractor 204 may identify anchor terms included in the text of a content item and determine a meaning of the anchor terms as further described in U.S. application Ser. No. 13/167,701, filed Jun. 24, 2011, which is hereby incorporated by reference in its entirety. For example, the feature extractor 204 determines one or more topics associated with a content item maintained in the content store 116. The one or more topics associated with a content item are stored in the content store 116. Structured information associated with a content item may also be used to extract a feature from the content item.

The feature store 114 is used to store features extracted from content items by the feature extractor 204. The feature store 114 may be organized as a database, table, file, etc. stored on one or more of removable or non-removable memory cards and computer hard drives. Examples of features include a topic of a content item, a type of product advertised by a content item, a content provider type of the content provider 106 who provided the content item, etc.

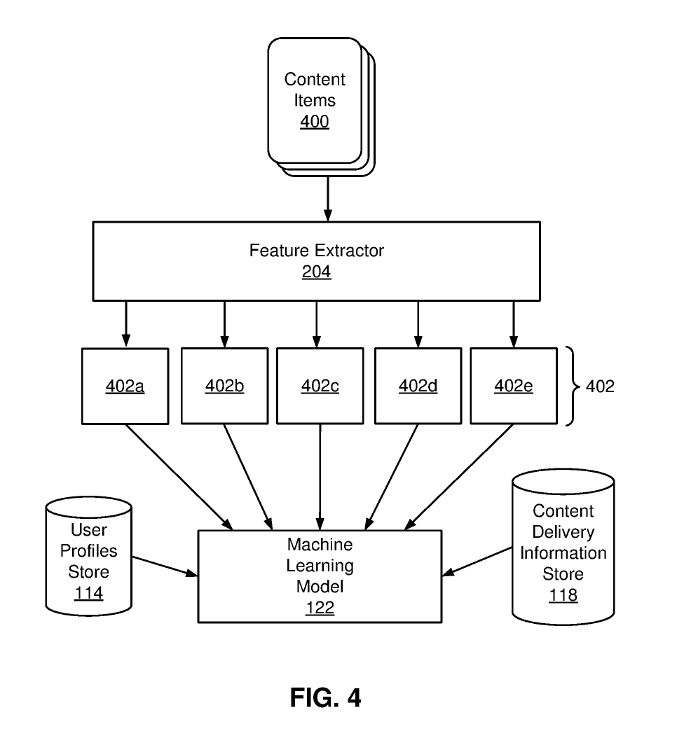

The machine learning training engine 206 trains the machine learning model 122 using training sets obtained from the content store 116, content delivery information store 118, user profiles store 210, and feature store 114. Each training set includes a feature vector for a content item, the information describing delivery of the content item to users of the online system 112, and the user profiles of the users who interacted with the content item. The process executed by the machine learning training engine 206 is illustrated and described below with reference to FIG. 4.

In an embodiment, users provide the training sets set by manually identifying content items, time periods having a high likelihood of a user interacting with the content item during the time period, time periods having a low likelihood of a user interacting with the content item during the time period, etc. In another embodiment, the machine learning training engine 206 extracts training sets from the information describing delivery of the content item to users of the online system 112. For example, past user interactions with content items represent user interactions that were performed by users responsive to being presented with content items including different types of features. If a past user interaction indicates that a user interacted with a content item during a particular time period responsive to being presented with the content item, the machine learning training engine 206 uses the content item as a positive training set. If a stored user interaction indicates that a user did not interact with a content item in a particular time period responsive to being presented with the content item, the machine learning training engine 206 uses the content item as a negative training set.

The machine learning model 122 is an analytical predictive model built from sample inputs that produces reliable, repeatable decisions and results and may uncover hidden insights through learning from historical relationships and trends in the stored information describing the delivery of the content items and feature vectors extracted from the content items. The machine learning model 122 generates a predicted performance metric for a content item for each time period of a plurality of time periods based on a feature vector extracted from the content item, resulting in the performance metrics vector 124. A time period may include one or more of a range of times of day (e.g., before 11 a.m. EST, between 2:00 and 4:00 p.m. EST, etc.), a range of days of week (e.g., Tuesdays and Wednesdays, weekends, holidays, etc.), a range of days of month (e.g., before the 7th day of a month), a range of months of year (e.g., summer months, particular months in a year, etc.), event days (e.g., March Madness, the Oscars, etc.), advertiser-specific event days (e.g., President's Day Mattress sales days).

In alternative embodiments, the performance metrics generator 208 generates the performance metrics vector 124. The performance metrics generator 208 generates, for the extracted content item type of a new content item, a predicted performance metric for each time period of several time periods. The generation includes filtering the stored information describing the delivery of the content items by the extracted content item type of the new content item to obtain information corresponding to the content item type. The performance metrics generator 208 determines, from the obtained information, an aggregate performance metric across other content items having the same content item type.

In one embodiment, the performance metrics generator 208 generates a performance metric for a time period by evaluating an expression representing a weighted aggregate of scores associated with features of the content item. The weight associated with a feature may be predetermined, for example, configured by an expert user. Features that are highly determinative of increased user interactions with the content item during a timer period are weighted more. In another example, a feature, e.g., that a content item contains an advertisement for a ski resort, is weighted less responsive to determining that the feature is associated with user interactions indicating users did not send the content item to their social networking connections responsive to interacting with the content item during the month of July.

In one embodiment, the online system 112 identifies stories likely to be of interest to a user through a “newsfeed” presented to the user. A story presented to a user describes an action taken by an additional user connected to the user and identifies the additional user. In some embodiments, a story describing an action performed by a user may be accessible to users not connected to the user that performed the action. A newsfeed manager may generate stories for presentation to a user based on information in the content delivery information store 118 and an edge store or may select candidate stories included in the content store 116. One or more of the candidate stories are selected and presented to a user by the newsfeed manager.

For example, the newsfeed manager receives a request to present one or more stories to a social networking user. The newsfeed manager accesses one or more of the user profiles store 210, the content store 116, the content delivery information store 118, and the edge store to retrieve information about the identified user. For example, stories or other data associated with users connected to the identified user are retrieved. The retrieved stories or other data is analyzed by the newsfeed manager to identify content likely to be relevant to the identified user during a particular time period. For example, stories associated with users not connected to the identified user or stories associated with users for which the identified user has less than a threshold affinity are discarded as candidate stories. Based on various criteria, the newsfeed manager selects one or more of the candidate stories for presentation to the identified user.

In various embodiments, the newsfeed manager presents stories to a user through a newsfeed, which includes a plurality of stories selected for presentation to the user. The newsfeed may include a limited number of stories or may include a complete set of candidate stories. The number of stories included in a newsfeed may be determined in part by a user preference included in user profiles store 210. The newsfeed manager may also determine the order in which selected stories are presented via the newsfeed. For example, the newsfeed manager determines that a user has a highest affinity for a specific user and increases the number of stories in the newsfeed associated with the specific user or modifies the positions in the newsfeed where stories associated with the specific user are presented.

The newsfeed manager may also account for actions by a user indicating a preference for types of stories and selects stories having the same, or similar, types for inclusion in the newsfeed. Additionally, the newsfeed manager may analyze stories received by the online system 112 from various users and obtains information about user preferences or actions from the analyzed stories. This information may be used to refine subsequent selection of stories for newsfeeds presented to various users. The online system 112 may process individual stories or a composite newsfeed of stories for targeting to different demographic audiences using the system disclosed herein. The online system 112 may determine suitable demographic criteria for a newsfeed using the disclosed embodiments.

In one embodiment, an edge store stores information describing connections between users and other objects, such as content items, on the online system 112 as edges. Some edges may be defined by users, allowing users to specify their relationships with other users. For example, users may generate edges with other users that parallel the users' real-life relationships, such as friends, co-workers, partners, and so forth. Other edges are generated when users interact with content items in the online system 112, such as expressing interest in a content item on the online system 112, sharing a link with other users of the online system 112, and commenting on a content item posted by other users of the online system 112. Users and objects within the online system can be represented as nodes in a social graph that are connected by edges stored in the edge store.

In one embodiment, an edge may include various characteristics, each representing characteristics of interactions between users, interactions between users and content items, etc. For example, characteristics included in an edge describe rate of interaction between two users, how recently two users have interacted with each other, the rate or amount of information retrieved by one user about a content item, or the number and types of comments posted by a user about a content item. The characteristics may also represent information describing a particular content item or user. For example, a characteristic may represent the level of interest that a user has in a particular topic, the rate at which the user logs into the online system 112, or information describing demographic information about a user. Each characteristic may be associated with a source content item or user, a target content item or user, and a characteristic value. A characteristic may be specified as an expression based on values describing the source content item or user, the target content item or user, or interactions between the source content item or user and target content item or user; hence, an edge may be represented as one or more characteristic expressions.

The edge store also stores information about edges, such as affinity scores for content items, interests, and other users. Affinity scores, or “affinities,” may be computed by the online system 112 over time to approximate a user's affinity for a content item, interest, and other users in the online system 112 based on the actions performed by the user. A user's affinity may be computed by the online system 112 over time to approximate a user's affinity for a content item, interest, and other users in the online system 112 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific content item may be stored as a single edge in the edge store, in one embodiment. Alternatively, each interaction between a user and a specific content item is stored as a separate edge. In some embodiments, connections between users may be stored in the user profiles store 210, or the user profiles store 210 may access the edge store to determine connections between users.

### Example Process

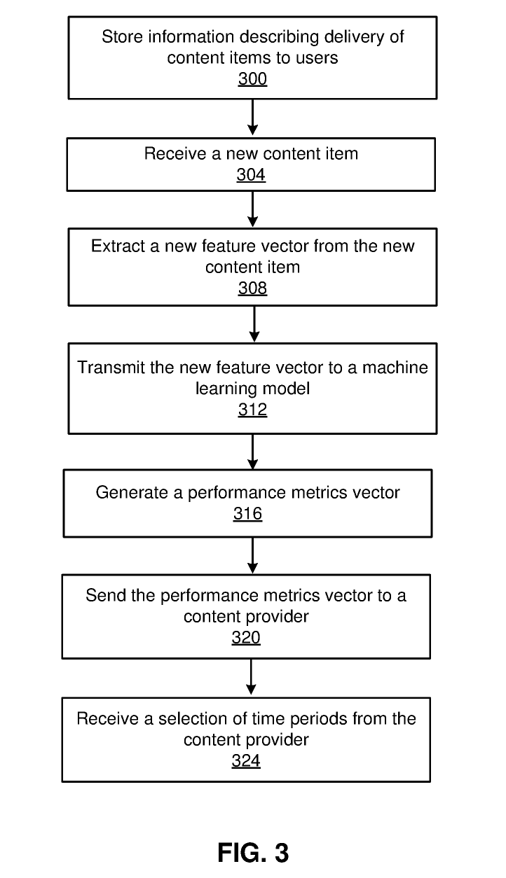

FIG. 3 is a flowchart illustrating an example process of predicting performance metrics for content items, in accordance with an embodiment. In some embodiments, the process may have different and/or additional steps than those described in conjunction with FIG. 3. Steps of the process may be performed in different orders than the order described in conjunction with FIG. 3. Some steps may be executed in parallel. Alternatively, some of the steps may be executed in parallel and some steps executed sequentially. Alternatively, some steps may execute in a pipelined fashion such that execution of a step is started before the execution of a previous step.

The online system 112 stores 300 information describing delivery of content items to users of the online system 112. The information for each delivery of a content item to a user includes a time of the delivery and a content item type of the content item delivered to the user. The online system 112 receives 304 a new content item from a content provider 106 for distribution by the online system 112. The feature extractor extracts 308 a new feature vector from the new content item. The new feature vector includes a content item type of the new content item.

The online system 112 provides 312 the extracted new feature vector to a machine learning model 122 that generates a predicted performance metric for a content item for each time period of several time periods based on a feature vector extracted from the content item. The machine learning model 122 is trained based on the stored information describing the delivery of the content items and feature vectors extracted from the content items. The machine learning model 122 generates a performance metrics vector 124 (a predicted performance metric for the new content item for each of the plurality of time periods) based on the new feature vector.

The online system 112 sends 320, to the content provider 106, the generated performance metrics vector 124 for the several time periods. The online system 112 receives 324, from the content provider 106, a selection of one or more time periods for delivering the new content item. The online system 112 delivers the new content item to the users of the online system 112 based on the selection of the one or more time periods.

### Example Machine Learning Training Process

FIG. 4 illustrates an example process for training the machine learning model 122 executed by the machine learning training engine 206. In some embodiments, the process may have different and/or additional steps than those described in conjunction with FIG. 4. Steps of the process may be performed in different orders than the order described in conjunction with FIG. 4. Some steps may be executed in parallel. Alternatively, some of the steps may be executed in parallel and some steps executed sequentially. Alternatively, some steps may execute in a pipelined fashion such that execution of a step is started before the execution of a previous step.

FIG. 4 and the other figures use like reference numerals to identify like elements. A letter after a reference numeral, such as “402a,” indicates that the text refers specifically to the element having that particular reference numeral. A reference numeral in the text without a following letter, such as “402,” refers to any or all of the elements in the figures bearing that reference numeral, e.g., “402” in the text refers to reference numerals “402a” and/or “402b” in the figures.

The content items 400 are electronic media content items received by the online system 112 from one or more content providers 106. The feature extractor 204 extracts a feature vector 402 including features 402a, 402b, etc. from each content item 400. The feature extractor 204 receives the content items 400 as input and extracts features 402a, 402b, etc. which are informative and non-redundant, facilitating training of the machine learning model 122. Redundant input data in the content items 400, such as the repetitiveness of images presented as pixels may be transformed into a reduced set of features (feature vector 402). The extracted features 402 contain the relevant information from the content items 400 such that the machine learning model 122 is trained by using this reduced representation instead of the complete initial data in the content items 400. The features 402 corresponding to content items 400 are used for training the machine learning model 122 based on information describing delivery of content items 400, which contain those features, to users of the online system 112.

The feature vector 402 may include a feature 402a describing a content item type of the content item, e.g., a type of product for which the content item is an advertisement. For example, the content item type may be an advertisement for ski resorts, a brand-awareness advertisement for a brand of automobiles, etc. A feature 410b may describe a content provider type of the content provider 106 providing the content item 400. For example, the content provider type may be the government, a particular corporation, a university, etc. A feature 410c may represent a topic of the content item, e.g., whether the content item is related to sports, music, etc. A feature 410d may represent the language of text in the content item, e.g., English, French, etc. A feature 410e may represent whether there is a hyperlink embedded in the content item and whether the hyperlink may be used by users of the online system 112 to purchase a product.

The machine learning training engine 206 trains the machine learning model 122 using training sets including information from the content store 116, the content delivery information store 118, user profiles store 210, and the feature store 114. In embodiments, the machine learning model 122 is thereby configured to receive a feature vector 402 for a content item 400 and generate a predicted performance metrics vector 124 based on the feature vector 402.

The predicted performance metrics vector 124 may indicate a likelihood of a user interacting with the content item 400 during each time period, e.g., whether a user has a 70% likelihood of interacting with a content item between 2:00 to 4:00 p.m. EST. The likelihood of a user interacting with the content item 400 during each time period may be represented as a click-through rate (CTR), which is the ratio of users who click on a specific link in the content item 400 to the number of total users who view a page, email, or advertisement. CTR may be used to measure the success of an online advertising campaign for a particular product or website as well as the effectiveness of email campaigns.

The predicted performance metrics vector 124 may indicate a likelihood of a user corresponding to a user profile interacting with the content item 400 during each time period, e.g., whether a user who is male has a 70% likelihood of interacting with a content item between 2:00 to 4:00 p.m. EST. The predicted performance metrics vector 124 may indicate a likelihood of a user interacting with other content items having the same content item type during the time period, e.g., whether a user has a 70% likelihood of interacting with other content items representing advertisements for carbonated beverages between 2:00 to 4:00 p.m. EST.

The predicted performance metrics vector 124 may indicate a cost of delivering the content item 400 during the time period, e.g., whether it costs the content provider more than 0.50 c for the online system 112 to deliver the content item to a user between 2:00 to 4:00 p.m. EST. The cost of delivering the content item 400 may be expressed as the cost per impression (CPI) or the cost per thousand impressions (CPM), which is the cost the content provider 106 pays each time a content item is displayed. CPI refers to the cost or expense incurred for each potential user who views the content item, while CPM refers to the cost or expense incurred for every thousand potential users who view the content item.

The predicted performance metrics vector 124 may indicate a reach of the content item during the time period, e.g., whether a content item will have a reach of 1,000,000 if delivered to users between 2:00 to 4:00 p.m. EST.

In embodiments, the machine learning model 122 is configured to generate a score for each time period indicative of a likelihood of a user interacting with a content item 400 during the time period. In an embodiment, the score is indicative of a predicted click-through rate of the content items 400, such as probabilities that the features 402 have a particular Boolean property or an estimated value of a scalar property. As part of the training of the machine learning model 122, the machine learning training engine 206 forms a training set of features 402, user profiles, and user interactions by identifying a positive training set of features that have been determined to have the property in question (increased user interactions during a certain time period), and, in some embodiments, forms a negative training set of features that lack the property in question. In one embodiment, the machine learning training engine 206 applies dimensionality reduction (e.g., via linear discriminant analysis (LDA), principle component analysis (PCA), or the like) to reduce the amount of data in the feature vector 402 to a smaller, more representative set of data.

The machine learning training engine 206 uses machine learning to train the machine learning model 122 with the feature vectors 402 of the positive training set and the negative training set serving as the inputs. Different machine learning techniques-such as linear support vector machine (linear SVM), boosting for other algorithms (e.g., AdaBoost), neural networks, logistic regression, naïve Bayes, memory-based learning, random forests, bagged trees, decision trees, boosted trees, or boosted stumps-may be used in different embodiments. The machine learning model 122, when applied to the feature vector 402 extracted from a content item 400, outputs an indication of whether the content item 400 has the property in question, such as a Boolean yes/no estimate, or a scalar value representing a probability.

In some embodiments, a validation set is formed of additional features, other than those in the training sets, which have already been determined to have or to lack the property in question. The machine learning training engine 206 applies the trained machine learning model 122 to the features of the validation set to quantify the accuracy of the machine learning model 122. Common metrics applied in accuracy measurement include: Precision=TP/(TP+FP) and Recall=TP/(TP+FN), where precision is how many the machine learning model 122 correctly predicted (TP or true positives) out of the total it predicted (TP+FP or false positives), and recall is how many the machine learning model 122 correctly predicted (TP) out of the total number of features that did have the property in question (TP+FN or false negatives). The F score (F-score=2×PR/(P+R)) unifies precision and recall into a single measure. In one embodiment, the machine learning training engine 206 iteratively re-trains the machine learning model 122 until the occurrence of a stopping condition, such as the accuracy measurement indication that the model is sufficiently accurate, or a number of training rounds having taken place.

### Example Execution of the Machine Learning Model

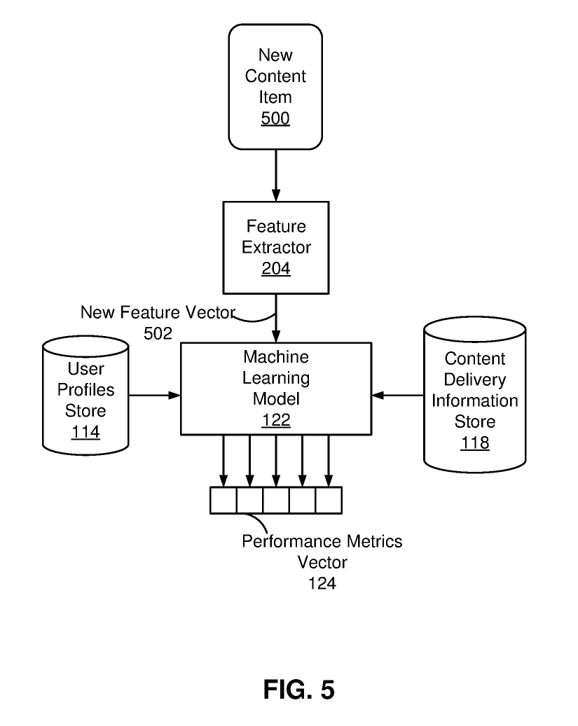

FIG. 5 illustrates an example process for generating the performance metrics vector 124 based on the machine learning model 122, in accordance with an embodiment. The execution procedure creates a performance metrics vector 124 for a new content item 500 that is input to the online system 112. In some embodiments, the process may have different and/or additional steps than those described in conjunction with FIG. 5. Steps of the process may be performed in different orders than the order described in conjunction with FIG. 5. Some steps may be executed in parallel. Alternatively, some of the steps may be executed in parallel and some steps executed sequentially. Alternatively, some steps may execute in a pipelined fashion such that execution of a step is started before the execution of a previous step.

The feature extractor 204 extracts a new feature vector 502 of features from the new content item 500 and sends the new feature vector 502 to the machine learning model 122. The machine learning model 122 compares the new feature vector 502 to the information stored in the user profiles store 114 and the content delivery information store 118 to generate a performance metrics vector 124 for the new content item 500 for several time periods.

For each time period, the machine learning model 122 may be configured to optimize the conditional probability that a user will interact with the new content item 500 based on the content item's features 502. In one embodiment, P(f_{c}) represents the probability that a given content item c has the feature f. In this embodiment, Pᵤ(interact_{c}) represents the probability that a user corresponding to user profile u interacts with given content item c. The machine learning model 122 is configured to optimize the sum Σ_{c}ΣᵤPᵤ(interact_{c}|f_{c}), which represents the sum of conditional probabilities over all user profiles and all content items that a user corresponding to user profile u interacts with given content item c, given that content item c has the feature f

In another embodiment, there may be more than one type of user interaction that is optimized. In this embodiment, Pᵤ(interact(t)_{c}) represents the probability that a user corresponding to user profile u interacts with given content item c in manner t. The machine learning model 122 is configured to optimize the sum ΣᵤΣₜΣ_{c}Pᵤ(interact(t)_{c}|f_{c}), which represents the sum of conditional probabilities over all users, all content items, and all types of user interactions that a user corresponding to user profile u interacts in a manner t (e.g., click, purchase, etc.) with given content item c, given that content item c has the feature f.

After a user has clicked on a content item on a webpage of the online system 122, the user may purchase a product related to the content item on a third-party website or a mobile application, or otherwise interact with a third-party website related to the content item. When the user's client device 102 receives a page from the third-party website, a tracking pixel may fire, causing the browser 104 to send information to the online system 122 about the user interactions performed by the user on the third-party web site. The online system 112 may also track such user interactions for content items. In one example having two types of interactions (“click” and “purchase a product”), the machine learning model 122 is configured to optimize the sum ΣᵤΣ_{c}Pᵤ(purchase_{c}|click_{c})×Pᵤ(click_{c}|f_{c}), where Pᵤ(purchase_{c}) is the probability that a user corresponding to user profile u will purchase the product represented by content item c, Pᵤ(click_{c}) is the probability that a user corresponding to user profile u will click on content item c, Pᵤ(purchase_{c}|click_{c}) is the conditional probability that a user corresponding to user profile u will purchase the product represented by content item c given that the clicks on content item c, and Pᵤ(click_{c}|f_{c}) is the is the conditional probability that a user corresponding to user profile u clicks on content item c given that content item c has the feature f In this example, the machine learning model 122 is configured to optimize the sum of conditional probabilities over all users and all content items that a user corresponding to user profile u will purchase the product represented by content item c given that content item c has the feature f.

### Example Performance Metric Aggregation Process

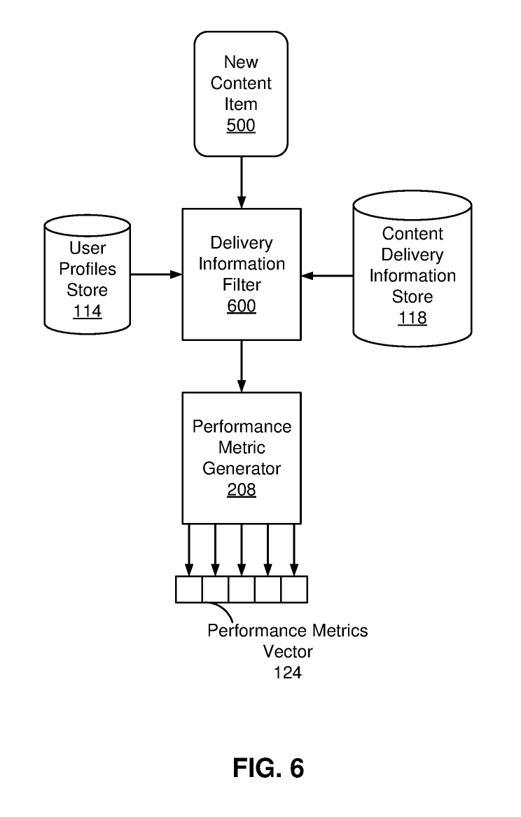

FIG. 6 illustrates an example process for generating a performance metrics vector 124 based on filtering content delivery information, in accordance with an embodiment. In some embodiments, the process may have different and/or additional steps than those described in conjunction with FIG. 6. Steps of the process may be performed in different orders than the order described in conjunction with FIG. 6. Some steps may be executed in parallel. Alternatively, some of the steps may be executed in parallel and some steps executed sequentially. Alternatively, some steps may execute in a pipelined fashion such that execution of a step is started before the execution of a previous step.

The process generates, for a new content item 500, a predicted performance metrics vector 124 for each time period of several time periods by filtering and aggregating information in the content delivery information store 118. The new content item 500 or new feature vector 502 is input to a delivery information filter 600. The delivery information filter 600 filters the stored information describing the delivery of the content items in the content delivery information store 118 by the extracted content item type of the new content item to obtain historic delivery information for past content items corresponding to the same content item type during each time period. The delivery information filter 600 may also filter information in the content delivery information store 118 by the extracted content provider type of the content provider 106 who provided the new content item 500 or a particular user profile supplied by the content provider 106 as input to the online system 112.

The performance metrics generator 208 may determine classifications, binaries, or other scores, based on the content item type or the content provider type of the new content item 500. In one embodiment, the performance metrics generator 208 determines a classification, binary, or score indicating the predicted user preference for every configurable or customizable attribute of the new content item 500 during a time period. In another embodiment, the performance metrics generator 208 may determine the performance metric for each time period by evaluating an expression representing a weighted aggregate of scores associated with features 502. In one example, the weight associated with a feature is predetermined, for example, configured by an expert user. Features that are most determinative of increased user interactions with the content item 502 during a time period are weighted more. In another example, a feature, e.g., that a content item 500 contains an advertisement for a ski resort, is weighted less responsive to determining that the feature is associated with user interactions indicating users did not send the content item 500 to their social networking connections after interacting with the content item during the month of July.

The online system 112 sends, to the content provider 106, the generated predicted performance metrics vector 124 for the plurality of time periods. The online system 112 receives, from the content provider 106, a selection of one or more time periods for delivering the new content item 500, e.g., instructing the online system 112 to deliver the content item three times to client devices 102 on Saturdays in July. The online system 112 delivers the new content item to the client devices 102 based on the selection of the one or more time periods.

### Alternative Embodiments

The foregoing description of the embodiments have been presented for the purpose of illustration; it is not intended to be exhaustive or to limit the embodiments to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product including a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may include information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based hereon. Accordingly, the disclosure of the embodiments of the is intended to be illustrative, but not limiting, of the scope of the embodiments, which is set forth in the following claims.

What is claimed is:

1. A method, comprising:
storing, by an online system, information describing delivery of content items to users of the online system, the information for each delivery of a content item to a user comprising a time of the delivery and a content item type of the content item delivered to the user;
receiving a new content item from a content provider for distribution by the online system;
extracting a new feature vector from the new content item, the new feature vector comprising a content item type of the new content item;
providing the extracted new feature vector to a machine learning model that generates a predicted performance metric for a content item for each time period of a plurality of time periods based on a feature vector extracted from the content item, the machine learning model trained based on the stored information describing the delivery of the content items and feature vectors extracted from the content items;
generating, by the machine learning model, a predicted performance metric for the new content item for each of the plurality of time periods based on the new feature vector;
sending, to the content provider, the generated predicted performance metrics for the plurality of time periods;
receiving, from the content provider, a selection of one or more time periods for delivering the new content item; and
delivering, by the online system, the new content item to the users of the online system based on the selection of the one or more time periods.

2. The method of claim 1, wherein the information for each delivery of a content item to a user further comprises one or more of:
a user profile of the user performing user interactions with the content item;
a number of the user interactions with the content item;
a cost of delivering the content item to the user;
a reach of the content item;
a number of deliveries of the content item; and
information describing past user interactions with other content items having the same content item type.

3. The method of claim 1, wherein the new feature vector further comprises a content provider type of the content provider.

4. The method of claim 1, further comprising:
extracting feature vectors from the content items; and
training the machine learning model, based on the stored information describing the delivery of the content items and the extracted feature vectors, to:
receive a feature vector for a content item, and
generate the predicted performance metric for the content item for each time period of the plurality of time periods based on the received feature vector.

5. The method of claim 1, wherein the generated predicted performance metric for each time period comprises one or more of:
a likelihood of a user interacting with the content item during the time period;
a likelihood of a user corresponding to a user profile interacting with the content item during the time period;
a likelihood of a user interacting with other content items having the same content item type during the time period;
a cost of delivering the content item during the time period; and
a reach of the content item during the time period.

6. The method of claim 5 wherein the user profile comprises one or more of:
financial status of the user;
age of the user;
gender of the user;
location of the user;
educational level of the user;
religious background of the user;
relationship status of the user;
location of employment of the user;
residence location of the user;
interests of the user;
parenting status of the user;
traveling preferences of the user;
dining preferences of the user; and
client device preferences of the user.

7. The method of claim 5, wherein the user profile comprises information describing social networking connections of the user, the information describing the social networking connections comprising one or more of:
an aggregate range of financial status of other users connected to the user;
an aggregate range of age of other users connected to the user;
an aggregate value based on genders of other users connected to the user;
an aggregate value based on locations of other users connected to the user;
an aggregate value based on educational levels of other users connected to the user;
an aggregate value based on relationship status of other users connected to the user;
an aggregate value based on locations of employment of other users connected to the user; and
an aggregate value based on residence locations of other users connected to the user.

8. The method of claim 1, wherein a time period comprises one or more of:
a range of times of day;
a range of days of week;
a range of days of month; and
a range of months of year.

9. The method of claim 1, further comprising:
receiving at least a portion of the information describing the delivery of the content items from client devices responsive to rendering tracking pixels on websites of the online system.

10. The method of claim 1, further comprising:
receiving at least a portion of the information describing the delivery of the content items from client devices responsive to rendering tracking pixels on third-party web sites.

11. A method, comprising:
storing, by an online system, information describing delivery of content items to users of the online system, the information for each delivery of a content item to a user comprising a time of the delivery and a content item type of the content item delivered to the user;
receiving a new content item from a content provider for distribution by the online system;
extracting, from the new content item, a content item type of the new content item;
generating, for the extracted content item type of the new content item, a predicted performance metric for each time period of a plurality of time periods, the generating comprising:
filtering the stored information describing the delivery of the content items by the extracted content item type of the new content item to obtain information corresponding to the content item type, and
determining, from the obtained information, an aggregate performance metric across other content items having the same content item type;
sending, to the content provider, the generated predicted performance metrics for the plurality of time periods;
receiving, from the content provider, a selection of one or more time periods for delivering the new content item; and
delivering, by the online system, the new content item to the users of the online system based on the selection of the one or more time periods.

12. The method of claim 11, wherein the information for each delivery of a content item to a user further comprises one or more of:
a user profile of the user performing user interactions with the content item;
a number of the user interactions with the content item;
a cost of delivering the content item to the user;
a reach of the content item;
a number of deliveries of the content item; and
information describing past user interactions with other content items having the same content item type.

13. The method of claim 11, further comprising:
extracting, from the new content item, a content provider type of the content provider;
generating, for the extracted content provider type of the new content item, a predicted performance metric for each time period of a plurality of time periods, the generating comprising:
filtering the stored information describing the delivery of the content items by the extracted content provider type of the new content item to obtain information corresponding to the content provider type, and
determining, from the obtained information, an aggregate performance metric across other content items having the same content provider type.

14. The method of claim 11, wherein the generated predicted performance metric for each time period comprises one or more of:
a likelihood of a user interacting with the content item during the time period;
a likelihood of a user corresponding to a user profile interacting with the content item during the time period;
a likelihood of a user interacting with other content items having the same content item type during the time period;
a cost of delivering the content item during the time period; and
a reach of the content item during the time period.

15. The method of claim 14 wherein the user profile comprises one or more of:
financial status of the user;
age of the user;
gender of the user;
location of the user;
educational level of the user;
religious background of the user;
relationship status of the user;
location of employment of the user;
residence location of the user;
interests of the user;
parenting status of the user;
traveling preferences of the user;
dining preferences of the user; and
client device preferences of the user.

16. The method of claim 14, wherein the user profile comprises information describing social networking connections of the user, the information describing the social networking connections comprising one or more of:
an aggregate range of financial status of other users connected to the user;
an aggregate range of age of other users connected to the user;
an aggregate value based on genders of other users connected to the user;
an aggregate value based on locations of other users connected to the user;
an aggregate value based on educational levels of other users connected to the user;
an aggregate value based on relationship status of other users connected to the user;
an aggregate value based on locations of employment of other users connected to the user; and
an aggregate value based on residence locations of other users connected to the user.

17. The method of claim 11, wherein a time period comprises one or more of:
a range of times of day;
a range of days of week;
a range of days of month; and
a range of months of year.

18. The method of claim 11, further comprising:
receiving at least a portion of the information describing the delivery of the content items from client devices responsive to rendering tracking pixels on websites of the online system.

19. The method of claim 11, further comprising:
receiving at least a portion of the information describing the delivery of the content items from client devices responsive to rendering tracking pixels on third-party websites.

20. A non-transitory computer-readable storage medium comprising instructions executable by a processor, the instructions comprising instructions for:
storing, by an online system, information describing delivery of content items to users of the online system, the information for each delivery of a content item to a user comprising a time of the delivery and a content item type of the content item delivered to the user;
receiving a new content item from a content provider for distribution by the online system;
extracting, from the new content item, a content item type of the new content item;
generating, for the extracted content item type of the new content item, a predicted performance metric for each time period of a plurality of time periods, the generating comprising:
filtering the stored information describing the delivery of the content items by the extracted content item type of the new content item to obtain information corresponding to the content item type, and
determining, from the obtained information, an aggregate performance metric across other content items having the same content item type;
sending, to the content provider, the generated predicted performance metrics for the plurality of time periods;
receiving, from the content provider, a selection of one or more time periods for delivering the new content item; and
delivering, by the online system, the new content item to the users of the online system based on the selection of the one or more time periods.
